(19) United States
(12) Patent Application Publication
(10) Pub. No.: US 2010/0183861 A1
(43) Pub. Date: Jul. 22, 2010

(54) LIGHT-REFLECTION COATING COMPOSITION AND FILMS

(76) Inventor: Kazufumi Ogawa, Awa-shi (JP)

Correspondence Address: Workman Nydegger;1000 Eagle Gate Tower, 60 East South Temple, Salt Lake City, UT, 84111, US

(21) Appl. No.: 12/666,971

(22) PCT Filed: Dec. 27, 2007
(86) PCT No.: PCT/JP2007/075399

§ 371 Date: Dec. 28, 2009

(51) Int. Cl. C09D 5/33; B32B 5/16; C09D 7/12; B32B 5/02; C09D 1/00

(52) U.S. Cl. 428/292.1; 106/2; 428/323; 428/324; 428/328; 428/403; 428/375

(57) ABSTRACT

The present invention relates to light-reflection coating composition, characterized in that transparent particles having surfaces covered with a water-repellent and oil-repellent coating film are dispersed in the coating composition. Furthermore, there is provided, using the coating composition, a water-repellent, oil-repellent, and soil-resistant light-reflection coat, wherein the transparent particles covered with a water-repellent, oil-repellent, and soil-resistant coating film.

### BACKGROUND OF THE INVENTION

1. Field of the Invention

The present invention relates to coating composition which constitutes a coating film having high light-reflection effect when applied. More specifically, it relates to the coating composition used for forming a light-reflection coating film which requires a soil-resistant function, used in a wall, a direction board, a display board, a traffic-control sign, or a tunnel wall. Further, it relates to a water-repellent, oil-repellent, and soil-resistant light-reflection coating film using the same.

2. Description of Related Art

Currently, there is the need for coating composition which constitutes a coating film having a high light-reflection effect when applied, used in a wall, a direction board, a display board, a traffic-control sign, or a tunnel wall. Additionally, there is the need for a soil-resistant coating film produced using such coating composition, which has high soil resistance and can maintain high light reflectance over the long periods.

Meanwhile, it has been already known well that a chemisorption liquid comprising a chlorosilane-based adsorbent containing a fluorocarbon group and a non-water-based organic solvent can be used to effect chemisorption in a liquid phase so as to form a water-repellent, oil-repellent, and soil-resistant chemisorption film in the form of a monomolecular film (for example, see Patent Document 1: Japanese Unexamined Patent Publication (Kokai) No. 02-258032).

A manufacture principle of the chemisorption monomolecular film in such a solution is in forming the monomolecular film by means of dehydrochlorination reaction between active hydrogen, such as a hydroxyl group on a substrate surface, and a chlorosilyl group of the chlorosilane-based adsorbent.

However, there has been a problem that a soil-resistant chemisorption film using a conventional chlorosilane-based adsorbent containing a fluorocarbon group is soil-resistant, but exhibits poor surface reflection performance.

The present invention is intended to provide coating composition capable of forming a soil-resistant coating film having excellent surface reflection performance, and a soil-resistant coating film having excellent surface reflection performance using the same.

### SUMMARY OF THE INVENTION

Accordingly, it would be advantageous to provide a light-reflection coating composition, characterized in that transparent particles and/or fibers having surfaces covered with a water-repellent and oil-repellent coating film are dispersed in the coating composition.

A second invention is, in the first invention, characterized in that the water-repellent and oil-repellent coating film is covalently bonded to the surface of the transparent particle and/or fiber.

A third invention is, in the first invention, characterized in that the water-repellent and oil-repellent coating film is a monomolecular film covalently bonded to the surface of the transparent particle and/or fiber.

A fourth invention is, in the first to third inventions, characterized in that the transparent particle and/or fiber is a translucent glass, silica, alumina particle and/or fiber, or a zirconia particle.

A fifth invention is, in the first to fourth inventions, characterized in that the composition includes a metal particle and/or fiber, or a mica particle.

A sixth invention is, in the fifth invention, characterized in that the size of the transparent particle and/or fiber, the metal particle and/or fiber, the mica particle, a pigment particle is at least greater than a wavelength of visible light.

A seventh invention is a water-repellent, oil-repellent, and soil-resistant light-reflection coat, wherein a transparent particle and/or fiber covered with a water-repellent, oil-repellent, and soil-resistant coating film is partially exposed on a surface of the film.

An eighth invention is, in the seventh invention, characterized in that the coating film includes a metal particle and/or fiber, a mica particle, or a pigment particle.

A ninth invention is, in the seventh invention, characterized in that a water-repellent and oil-repellent coating film is covalently bonded to a surface of the transparent particle and/or fiber.

A tenth invention is, in the seventh invention, characterized in that the water-repellent and oil-repellent coating film is a monomolecular film covalently bonded to the surface of the transparent particle and/or fiber.

More particularly, the present invention is summarized to provide the light-reflection coating composition, characterized in that at least the transparent particles and/or fibers having surfaces covered with the water-repellent and oil-repellent coating film are dispersed in the coating composition.

Here, it is advantageous in order to improve soil resistance and durability when the water-repellent and oil-repellent coating film is covalently bonded to the surface of the transparent particle and/or fiber.

In addition, it is advantageous in order to improve reflectance when the water-repellent and oil-repellent coating film is the monomolecular film covalently bonded to the surface of the transparent particle and/or fiber.

Further, it is advantageous in order to improve the reflectance when the transparent particle and/or fiber is the translucent glass, silica, or alumina particle and/or fiber, or the zirconia particle.

Furthermore, it is advantageous in order to improve the reflectance when the coating composition includes the metal particle and/or fiber, the mica particle, or the pigment particle.

Moreover, it is advantageous in order to improve the reflectance when the size of the transparent particle and/or fiber, the metal particle, the mica particle, or the pigment particle is at least greater than the wavelength of visible light, wherein the size is preferably 5 mm to 1 μm. More preferably, it is 100 μm to 5 μm.

Furthermore, the present invention is summarized to provide the water-repellent, oil-repellent, and soil-resistant light-reflection coat, wherein at least the transparent particle and/or fiber covered with the water-repellent, oil-repellent, and soil-resistant coating film is partially exposed on the surface of the film.

Here, it is advantageous in order to improve the reflectance of the coating film when the coating film includes the metal particle having the high light reflectance, such as silver, aluminum, or stainless steel, the mica particle, or the pigment particle.

In addition, it is advantageous in order to improve the reflectance of the coating film when the water-repellent and oil-repellent coating film is covalently bonded to the surface of the transparent particle and/or fiber.

Further, it is advantageous in order to improve the reflectance of the coating film when the water-repellent and oil-repellent coating film is the monomolecular film covalently bonded to the surface of the transparent particle and/or fiber.

### BRIEF DESCRIPTION OF THE DRAWINGS

FIG. 1 is a conceptual diagram enlarged to a molecular level for illustrating process of forming a fluorocarbon-based monomolecular film on a surface of a glass particle in a first example of the present invention, wherein 1A is a sectional view of the glass particle before reaction and 1B is a sectional view thereof after the monomolecular film containing a fluorocarbon group is formed; and

FIG. 2 shows a state where the glass particle is fixed to a surface of a wall via an acrylic resin film serving as a binder in the first example of the present invention.

### DETAILED DESCRIPTION

As has been described, according to the present invention, there is an advantage that it can provide coating composition capable of forming a soil-resistant coating film having excellent surface reflection performance, and a water-repellent, oil-repellent, and soil resistant light-reflection coat, which has soil resistance, the excellent surface reflection performance, and high durability, using the same.

The present invention provides light-reflection coating composition, wherein transparent particles and/or fibers, at least surfaces thereof being coated with a water-repellent and oil-repellent coating film made of a fluorocarbon-based chemisorption monomolecular film using a chemisorption method, are dispersed in the coating composition.

Additionally, it provides a water-repellent, oil-repellent, and soil-resistant light-reflection coat, wherein the transparent particles and/or fibers, at least the surfaces thereof being coated with a water-repellent, oil-repellent, and soil-resistant coating film made of the fluorocarbon-based chemisorption monomolecular film using the chemisorption method, are partially exposed on the surface of the film.

Hence, the present invention has an effect that it is possible to provide the coating composition capable of forming a soil-resistant coating film having excellent surface reflection performance, and a water-repellent, oil-repellent, and soil-resistant light-reflection coat, which has soil resistance, the excellent surface reflection performance, and high durability, using the same.

Although the invention of the present application will be described in detail with reference to examples hereinafter, the invention of the present application is not limited by these examples in any degree.

Incidentally, while the coating composition according to the present invention includes the coating composition which constitutes the water-repellent, oil-repellent, and soil-resistant light-reflection coating film having a high light-reflection effect when applied, used in a wall, a direction board, a display board, a traffic-control sign, or a tunnel wall, the coating film on the tunnel wall will be described as a representative example.

### First Example

A chemisorption liquid is preliminarily prepared by weighing 99 weight % of an agent represented by CF₃(CF₂)₇(CH₂)₂Si(OCH₃)₃, for example, containing a fluorocarbon group (—CF₃) on one end and a alkoxysylil group on the other end, and 1 wt % of dibutyltin diacetylacetonate, for example, as a silanol condensation catalyst, respectively, and by dissolving them in a silicone solvent, a hexamethyldisiloxane solvent for example, by concentration of approximately 1 wt % (preferable concentration of a chemisorption agent is approximately 0.5 to 3%).

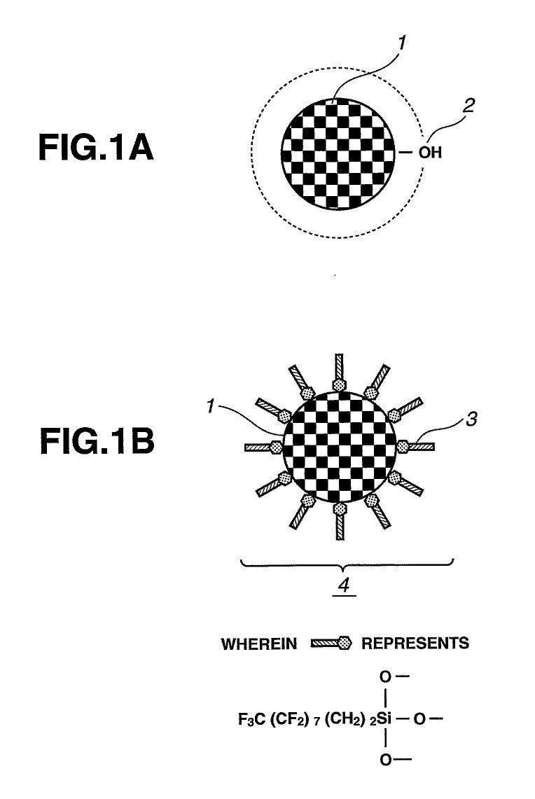

Meanwhile, a glass particle 1 having the size of 10 to 30 microns is prepared, sufficiently dried, mixed in the chemisorption liquid, and caused to react for approximately 1 hour while agitating in atmospheric air (relative humidity of 45%) (The particle may be a particle and/or fiber of silica, alumina, or zirconia, as long as it is transparent. For the purpose of increasing light reflectance of the wall, the size of the particle and/or fiber is preferably greater than a wavelength of visible light (380 to 700 nm) and similar to a thickness of the coat, namely preferably 5 mm to 1 μm and more preferably 100 μm to 5 μm). At this time, since the surface of the glass particle 1 contains many hydroxyl groups 2 (FIG. 1A), a —Si(OCH₃) group of the chemisorption agent and the hydroxyl group 2 undergo dealcoholization condensation (in this case, CH₃OH is removed) under the presence of the silanol condensation catalyst, to form bondings as represented by the following formula (Formula 2), and a chemisorption monomolecular film 3 containing the fluorocarbon group, having a film thickness of approximately 1 nm, as represented by the following formula (Formula 1) is formed over the entire surface of the glass particle 1 in a state chemically bonded to the particle surface.

Thereafter, by washing off the excess unreacted adsorbent using a chlorine-based solvent, such as chloroform, alcohol, or the like, a water-repellent and oil-repellent glass particle, the entire surface thereof being covered with a chemisorption monomolecular film containing the fluorocarbon group, which has been chemically bonded to the surface (the glass particle having the surface covered with the water-repellent and oil-repellent chemisorption monomolecular film), can be manufactured (FIG. 1B)). Incidentally, when it is not necessarily the monomolecular film, process of washing off may be eliminated.

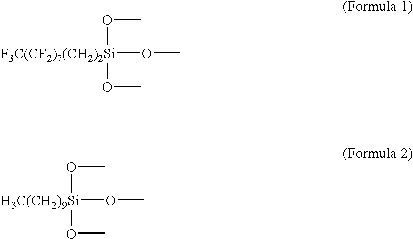

Meanwhile, the coating composition serving as a binder of the glass particle when the solvent is vaporized, a water-soluble acrylic coating composition containing a white pigment, for example, is prepared, in which the water-repellent and oil-repellent glass particle 4, having the surface covered with the chemisorption monomolecular film containing the fluorocarbon group, is mixed by agitation. Here, a color tone of the coating composition serving as the binder may be arbitrarily selected in accordance with the purpose.

Thereafter, by applying the coating composition on a wall 5 by the film thickness of approximately 30 microns and vaporizing the solvent, a light-reflection coating film 6 having excellent water-repellent, oil-repellent, and soil-resistant properties can be formed.

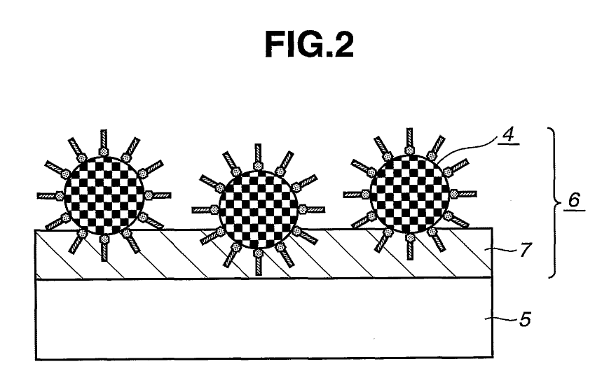

Incidentally, in this case, since the glass particle 4 covered with the chemisorption monomolecular film containing the fluorocarbon group has the water-repellent and oil-repellent surface, as shown in FIG. 2, it emerges and is exposed on the coating composition after application without being buried in an acrylic resin film 7, to constitute the light-reflection coating film 6 having irregularities of a few to ten microns on the surface thereof.

Further, since the glass particle is covered with the water-repellent and oil-repellent monomolecular film, apparent surface energy thereof as the coating film is extremely small, that is 2-3 mN/m, due to the lotus effect, and the water-repellent, oil-repellent, and soil-resistant performance thereof is extremely high.

Furthermore, since the glass particle exposed on the surface of the coating film is only covered with the very thin film having the thickness of 1 nm with no light blocking effect at all, it has the extremely high light-reflection effect in a direction of light incidence. Moreover, since this monomolecular film is integral with the surface of the glass particle by covalent bonding, it is not stripped off and has the extremely high durability.

Meanwhile, in the case where an organic-based solvent, such as xylene, instead of the water-based solvent, the similar coating film can also be formed because the water-repellent and oil-repellent monomolecular film is formed on the surface of the particle.

Further, in this case, if the coating composition includes a metal particle having the high light reflectance, a mica particle, or a pigment, leakage of light through a back surface of the glass particle, resulting in the coating film with the further improved light reflectance. Note herein that the size of the transparent particle, the metal particle, or the mica particle, to be mixed therein must be at least greater than the wavelength of visible light. When it is smaller than that, the light passes therethrough, causing it meaningless.

Incidentally, although the fluorocarbon-based chemisorption agent, CF₃(CF₂)₇(CH₂)₂Si(OCH₃)₃, is used as the agent for forming the oil-repellent monomolecular film in the above-described first example, substances represented in the following (1) to (12) can be used other than the above example.

(1) CF₃CH₂O(CH₂)₁₅Si(OCH₃)₃

(2) CF₃(CH₂)₃Si(CH₃)₂(CH₂)₁₅Si(OCH₃)₃

(3) CF₃(CF₂)₅(CH₂)₂Si(CH₃)₂(CH₂)₉Si(OCH₃)₃

(4) CF₃(CF₂)₇(CH₂)₂Si(CH₃)₂(CH₂)₉Si(OCH₃)₃

(5) CF₃COO(CH₂)₁₅Si(OCH₃)₃

(6) CF₃(CF₂)₅(CH₂)₂Si(OCH₃)₃

(7) CF₃CH₂O(CH₂)₁₅Si(OC₂H₅)₃

(8) CF₃(CH₂)₃Si(CH₃)₂(CH₂)₁₅Si(OC₂H₅)₃

(9) CF₃(CF₂)₅(CH₂)₂Si(CH₃)₂(CH₂)₉Si(OC₂H₅)₃

(10) CF₃(CF₂)₇(CH₂)₂Si(CH₃)₂(CH₂)₉Si(OC₂H₅)₃

(11) CF₃COO(CH₂)₁₅Si(OC₂H₅)₃

(12) CF₃(CF₂)₅(CH₂)₂Si(OC₂H₅)₃

Further, in the first example, it is possible, as the silanol condensation catalyst, to use carboxylic acid metal salts, carboxylate ester metal salts, carboxylic acid metal salt polymers, carboxylic acid metal salt chelates, titanates, and titanate chelates. More specifically, it is possible to use stannous acetates, dibutyltin dilaulates, dibutyltin dioctates, dibutyltin diacetates, dioctyltin dilaurates, dioctyltin dioctates, dioctyltin diacetates, stannous dioctates, lead naphthenates, cobalt naphthenates, 2-ethyl hexenic acid irons, dioctyltin-bis-octyltioglicolate salts, dioctyltin maleate salts, dibutyltin maleate polymers, dimethyltin mercaptopropionate polymers, dibutyltin bis-acetyl acetates, dioctyltin bis-acetyllaurates, tetrabutyl titanates, tetranonyl titanates, and bis(acetylacetonyl)di-propyltitanates.

Incidentally, in the first example, when the silanol condensation catalyst is not used, the substances as represented in the following (41) to (52) can be used.

(41) CF₃CH₂—O—(CH₂)₁₅SiCl₃

(42) CF₃(CH₂)₃Si(CH₃)₂(CH₂)₁₅SiCl₃

(43) CF₃(CF₂)₅(CH₂)₂Si(CH₃)₂(CH₂)₉SiCl₃

(44) CF₃(CF₂)₇(CH₂)₂Si(CH₃)₂(CH₂)₉SiCl₃

(45) CF₃COO(CH₂)₁₅SiCl₃

(46) CF₃(CF₂)₅(CH₂)₂Si(NCO)₃

(47) CF₃CH₂—O—(CH₂)₁₅Si(NCO)₃

(48) CF₃(CH₂)₃Si(CH₃)₂(CH₂)₁₅Si(NCO)₃

(49) CF₃(CF₂)₅(CH₂)₂Si(CH₃)₂(CH₂)₅Si(NCO)₃

(50) CF₃(CF₂)₇(CH₂)₂Si(CH₃)₂(CH₂)₅Si(NCO)₃

(51) CF₃COO(CH₂)₁₅Si(NCO)₃

(52) CF₃(CF₂)₅(CH₂)₂Si(NCO)₃

Meanwhile, in any case where the chemisorption agent is alkoxysilane-based or chlorosilane-based, the solvent of a film-forming solution can include an organochlorine-based solvent having no water content, a hydrocarbon-based solvent, a fluorocarbon-based solvent, a silicone-based solvent, or a mixture thereof. Incidentally, in order to increase particle density by vaporizing the solvent without washing off, a boiling point of the solvent is preferably 50 to 250 degrees C.

The specifically available solvent can include, in the case of the chlorosilane-based solvent, non-water-based petroleum naphtha, solvent naphtha, petroleum ether, petroleum benzine, isoparaffin, normal paraffin, decalin, industrial gasoline, nonane, decane, kerosene, dimethyl silicone, phenyl silicone, alkyl-modified silicone, polyether silicone, dimethylformamide, or the like.

Further, in the case where the alkoxysilane-based adsorbent is used and an organic coating film is formed by vaporizing the solvent, it is possible to use, in addition to the above-described solvent, an alcohol-based solvent, such as methanol, ethanol, propanol, and the like, or a mixture thereof.

Meanwhile, the fluorocarbon-based solvent includes a flon-based solvent, Florinate (from 3M, U.S.), Aflude (from Asahi Glass Co., Ltd.), or the like. Incidentally, one of them may be singularly used, or two or more of them may be combined as long as they are mixed well. Further, the organochlorine-based solvent, such as chloroform, may be added.

Meanwhile, in the case where, a ketimine compound, organic acid, metal oxide, such as TiO₂, an aldimine compound, an enamine compound, an oxazolidine compound, or an aminoalkylalkoxysilane compound is used instead of the above-described silanol condensation catalyst, processing time can be reduced to about half to two-third under the same concentration condition.

Further, by mixing the silanol condensation catalyst with the ketimine compound, the organic acid, the metal oxide, such as TiO₂, the aldimine compound, the enamine compound, the oxazolidine compound, or the aminoalkylalkoxysilane compound (they may be used in a range of a ratio of 1:9 to 9:1, though approximately 1:1 is generally desired), the processing time can be further reduced to a few tenths, resulting in reduction in film-formation time to a few tenths.

For example, under the same conditions, except that dibutyltin oxide as the silanol catalyst is replaced by H3 from Japan Epoxy Resin Co., Ltd. as the ketimine compound, the similar result can be obtained except that reaction time can be reduced to approximately 1 hour.

Further, under the same conditions, except that the silanol catalyst of H3 from Japan Epoxy Resin Co., Ltd. as the ketimine compound is replaced by a dibutyltin bis(acetylacetonate) mixture (mixing ratio of 1:1) as the silanol condensation catalyst, the similar result can be obtained except that the reaction time can be reduced to approximately 20 minutes.

Hence, from the above-described results, it has been proved that the ketimine compound, the organic acid, the aldimine compound, the enamine compound, the oxazolidine compound, and the aminoalkylalkoxysilane compound have the higher activity than that of the silanol condensation catalyst.

Furthermore, it has been proved that mixing one of the ketimine compound, the organic acid, the aldimine compound, the enamine compound, the oxazolidine compound, and the aminoalkylalkoxysilane compound with the silanol condensation catalyst further increases the activity.

Note herein that, the available ketimine compound includes, but not specifically limited to, for example, 2,5,8-triaza-1,8-nonadiene, 3,11-dimethyl-4,7,10-triaza-3,10-tridecadiene, 2,10-dimethyl-3,6,9-triaza-2,9-undecadiene, 2, 4, 12, 14-tetramethyl-5,8,11-triaza-4,11-pentadecadiene, 2,4,15,17-tetramethyl-5,8,11,14-tetraaza-4,14-octadecadiene, 2,4,20,22-tetramethyl-5,12,19-triaza-4,19-trieicosadiene, or the like.

Additionally, the available organic acid can include, but not specifically limited to, for example, formic acid, acetic acid, propionic acid, butyric acid, malonic acid, and the like, wherein any of them exhibits the similar result.

1. A light-reflection coating composition, wherein transparent particles and/or fibers having surfaces covered with a water-repellent and oil-repellent coating film are dispersed in the coating composition.

2. The light-reflection coating composition according to claim 1, wherein the water-repellent and oil-repellent coating film is covalently bonded to the surface of the transparent particle and/or fiber.

3. The light-reflection coating composition according to claim 1, wherein the water-repellent and oil-repellent coating film is a monomolecular film covalently bonded to the surface of the transparent particle and/or fiber.

4. The light-reflection coating composition according to claim 1, wherein the transparent particle and/or fiber is a translucent glass, silica, alumina particle and/or fiber, or a zirconia particle.

5. The light-reflection coating composition according to claim 1, wherein the composition further includes a metal particle and/or fiber, a mica particle, or a pigment.

6. The light-reflection coating composition according to claim 5, wherein the size of the transparent particle and/or fiber, the metal particle and/or fiber, the mica particle, the pigment particle is at least greater than a wavelength of visible light.

7. A water-repellent, oil-repellent, and soil-resistant light-reflection coat, wherein a transparent particle and/or fiber covered with a water-repellent, oil-repellent, and soil-resistant coating film is partially exposed on a surface of the film.

8. The water-repellent, oil-repellent, and soil-resistant light-reflection coating film according to claim 7, wherein the coating film further includes a metal particle and/or fiber, a mica particle, or a pigment particle.

9. The water-repellent, oil-repellent, and soil-resistant light-reflection coating film according to claim 7, wherein the water-repellent and oil-repellent coating film is covalently bonded to a surface of the transparent particle and/or fiber.

10. The water-repellent, oil-repellent, and soil-resistant light-reflection coating film according to claim 7, wherein the water-repellent and oil-repellent coating film is a monomolecular film covalently bonded to the surface of the transparent particle and/or fiber.
